(19) United States
(12) Patent Application Publication
(10) Pub. No.: US 2014/0131990 A1
(43) Pub. Date: May 15, 2014

(54) METHOD OF PROCESSING A SECURITY ITEM

(71) Applicant: Maxim Zolotukhin, Basingstoke (GB)

(72) Inventor: Maxim Zolotukhin, Basingstoke (GB)

(73) Assignee: Andrews & Wykeham Limited, Basingstoke (GB)

(21) Appl. No.: 14/110,243

(22) PCT Filed: Apr. 4, 2012
(86) PCT No.: PCT/GB2012/050762

§ 371 Date: Jan. 15, 2014

(30) Foreign Application Priority Data
Apr. 8, 2011 (GB) 1106020.9

(51) Int. Cl. B23K 26/38; B42D 15/00

(52) U.S. Cl. CPC B23K 26/38; B42D 15/0013
USPC 283/86; 219/121.72; 219/121.67

(57) ABSTRACT

There is disclosed a method of processing a security item 1. The security item comprises a holographic security feature 2 having at least one metallised layer. The holographic security feature 2 is applied to the reverse of a substantially transparent film through which the holographic security feature is viewed in use of the security item. The transparent film protects the holographic security feature from the environment in the finished security item. The method includes the step of applying laser radiation to the metallised layer of the holographic security feature through the transparent film to remove a portion of the metallisation to define a pattern of identifying information on the holographic security feature. The method has the advantage that the hologram can be customised with identifying information after manufacture of the security item.

This invention relates to a method of processing a security item.

### BACKGROUND

It is known to incorporate a holographic security feature into security items, such as vehicle licence plates, passports, credit cards and identity cards. The hologram increases the cost and complexity of counterfeiting. However, it is desirable to further increase the security of such items.

### BRIEF SUMMARY OF THE DISCLOSURE

In accordance with the present invention there is provided a method of processing a security item. The security item comprises a holographic security feature having at least one metallised layer. The holographic security feature is applied to the reverse of a substantially transparent film through which the holographic security feature is viewed in use of the security item such that the transparent film protects the holographic security feature from the environment in the finished security item. The method comprises the step of applying laser radiation to the metallised layer of the holographic security feature through the transparent film to remove, for example by evaporation, a portion of the metallisation to define a pattern of identifying information on the holographic security feature.

Thus, in accordance with the invention, the holographic security feature can be customised or personalised with identifying information even after the protective transparent film has been applied to the security item. This means that robust, finished security items can be provided for customisation, rather than customisation necessarily being part of the manufacturing process for the security item. This greatly increases the flexibility for including secure identifying information in the security item, which in turn increases the complexity of counterfeiting.

In incident light the holographic security feature may comprise any of the rainbow, kinetic, depth, colour change and image switch effects, other non-rainbow diffraction based effects such as achromatic images, or non-diffractive micrographics or coded images generated using typical hologram origination devices such as an electron beam lithograph.

Typically, the pattern of identifying information is alphanumeric. For example, the identifying information may be a vehicle registration number (VRN), a vehicle identification number (VIN), a passport number or the like. The identifying information may be a serial number or other arbitrary alphanumeric identifier. Alternatively, the pattern may be a machine-readable identifier, such as a bar code or the like.

The pattern of identifying information may be specific to the particular security item. Thus, the identifying information may be unique to the particular security item, for example in the case of the vehicle registration number of a vehicle licence plate. Alternatively, the identifying information may be an arbitrary unique identifier that is associated with the security item in a database.

In an advantageous embodiment, the security item comprises an optically active layer (fluorescent, phosphorescent, colour-switching) layer on the opposite side of the metallised layer to the transparent film. In this way, the optically active layer will be visible through the regions of the metallised layer that are removed to form the pattern of identifying information. In this case, when the security item is illuminated with light or radiation of appropriate wavelength, for example visible, ultra-violet or infra-red, the optically active layer pattern will respond to such light or radiation, for example, by fluorescing, in the regions of the metallised layer that are removed to form the pattern of identifying information. The response of the optically active layer detectable in the regions of the metallised layer that are removed to form the pattern of identifying information provides an additional security feature to hinder counterfeiting.

The identifying information may be provided to a computer controlling the laser by an operator or from a table of identifying information stored in the computer or from an algorithm generating identifying information. In an advantageous embodiment, however, the step of applying laser radiation to the metallised layer comprises machine-reading information from the security item in order to determine the identifying information to be applied to the holographic security feature. Thus, the computer controlling the laser may be connected to an imaging device, such as a camera, that images the security item to read machine-read information from the security item. The identifying information may be read directly from the security item. For example, a camera may read a vehicle registration number from a vehicle licence plate so that the laser can apply the pattern of identifying information, for example the same vehicle registration number, to the metallised layer of the holographic security feature.

Additionally, the step of determining the identifying information may include looking up the information read from the security item in a database. For example, the computer controlling the laser may read the vehicle registration number from a vehicle licence plate and then retrieve the corresponding vehicle identification number (VIN) from the database to apply it to the holographic security feature.

The security item may be, for example, a vehicle licence plate an identity card, a passport or other security document or packaging for a product.

Alternatively, the security item may be a laminate material. In this case, the laminate material may be applied later to a product. The laminate material may be customised by application of the pattern of identifying information to the holographic security feature(s) before or after the laminate is applied to the product.

The laminate material may comprise an adhesive on a surface opposed to the surface of the transparent film. Thus, the laminate material may be configured for further lamination to other layers of a product. A releasing backing paper or film may be provided to cover the adhesive until the laminate material is applied to a product.

The laminate material may comprise layers in addition to those described above. For example, the laminate material may comprise a retroreflective security laminate. In this case the laminate may contain the transparent protective film with the holographic security feature, a retroreflective layer comprising optical elements (e.g. lenses, beads or prisms) with reflective metallisation behind them and an adhesive. In this case, the laminate material may be applied to an aluminium or plastic base to form a vehicle licence plate.

The invention extends to a security item adapted for processing in accordance with the method of the invention. The invention also extends to a computer-controlled laser configured to carry out the method of the invention. The invention further extends to a security item processed in accordance with the method of the invention.

### BRIEF DESCRIPTION OF THE DRAWINGS

Embodiments of the invention are further described hereinafter with reference to the accompanying drawings, in which:

FIG. 1 is a schematic representation of a vehicle licence plate with a retroreflective security laminate incorporating a holographic security feature in accordance with an embodiment of the invention;

FIG. 2 is a schematic cross section of the layer structure of the licence plate of FIG. 1 along the line A-A of FIG. 1;

FIG. 3 is a schematic representation of the layer structure of the holographic security feature in the embodiment of FIG. 1 before application to the protective film; and

FIG. 4 is a schematic representation of the of the layer structure of the holographic security feature in the embodiment of FIG. 1 after application to the protective film.

### DETAILED DESCRIPTION

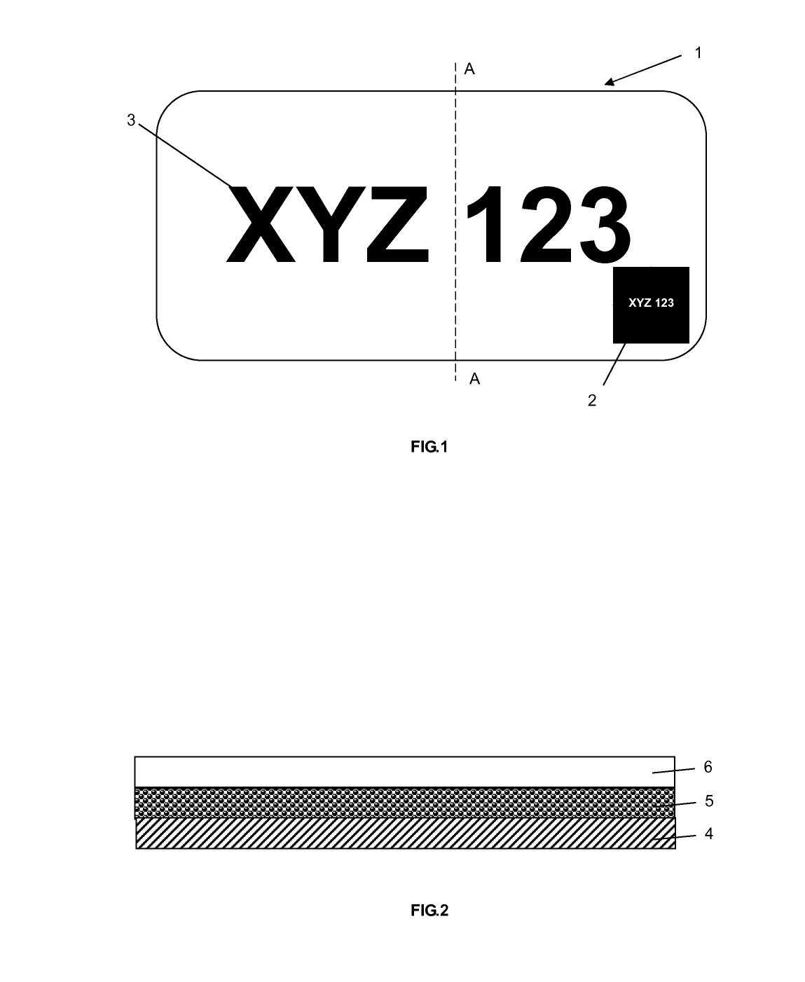

FIG. 1 is a schematic representation of a security item, in the form of a vehicle licence plate 1, incorporating a holographic security feature 2 in accordance with an embodiment of the invention. The licence plate 1 is printed or embossed with the vehicle registration number 3. In accordance with an embodiment of the invention, the vehicle registration number is also incorporated into the holographic security feature 2, as shown in FIG. 1, by evaporating the corresponding alphanumeric sequence from the metallised layer of the security feature through the transparent protective film, as will be described in the following.

As shown in FIG. 2, the structure of the basic licence plate 1 of FIG. 1 comprises a base 4, for example a sheet of aluminium or plastic and a retroreflective laminate. The retroreflective laminate comprises a retroreflective layer 5 containing optical elements such as beads, lenses, prismatic elements with metallisation on the side of the base material 4. The retroreflective layer is designed to reflect light shining on the licence plate 1 to make the licence plate visible in the dark and provide a high contrast image of the vehicle registration number. The retroreflective laminate also comprises a protective film 6 which provides the outer surface of the licence plate and protects the retroreflective layer from the environment. The protective film 6 is typically formed of PVC. In accordance with the invention, the holographic security feature 2 is located between the retroreflective layer 5 and the protective film 6. The structure may include another transparent filmic layer on top of the retroreflective layer to which the protective film 6 is applied. All layers are typically bonded with adhesives.

In accordance with the invention, the retroreflective laminate of the licence plate is provided with a holographic security feature 2 on the reverse of the protective film 6 in order that the holographic security feature 2 is located between the retroreflective layer 5 and the protective film 6 when the protective film 6 is applied to the retroreflective layer 5. The protective film 6 with the holographic security feature 2 pre-applied to the reverse can be provided as a continuous material for manufacture of the retroreflective laminate and, consequently, licence plates. The protective film 6 may be provided with an outer carrier film which supports the protective film 6 during the application of the holographic security feature 2 and during the manufacture of the retroreflective laminate.

The holographic security feature 2 may comprise holographic hot-stamping foil and may be applied to the reverse of the protective film 6 via a hot-stamping process. Alternatively the holographic security feature 2 may comprise a holographic self-adhesive label and may be applied to the reverse of the protective film layer 6 using pressure-sensitive adhesive.

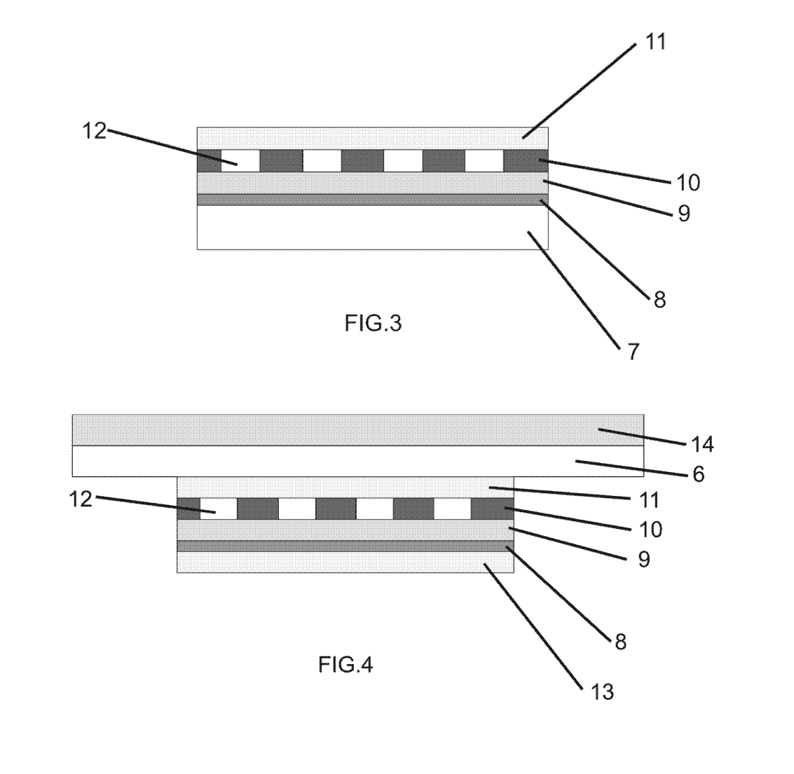

FIG. 3 shows schematically the layer structure of the holographic security feature 2 comprising holographic hot-stamping foil before it is applied to the protective film 6. The feature's structure comprises a carrier layer 7, typically PET film, which provides physical support to the holographic structure before and during application to the protective film 6.

The carrier layer 7 is provided with a typically transparent release layer 8 which allows the carrier layer to be separated from the holographic structure during application to the protective film 6. An embossable layer 9, typically comprising transparent acrylic, contains the holographic grating. The metallisation layer 10 increases the brightness and improves readability of the diffractive image of the hologram. This metallised layer 10 is normally applied to the holographic foil using vacuum thermal evaporation or a sputtering process. In this way, the thin metallised layer 10 assumes the shape of the upper surface of the embossable layer 9, which forms the holographic grating. The metallised layer 10 generally comprises aluminium, copper, chromium, other reflective metals, oxides, salts or other reflective compounds. Advantageously during the manufacture of the holographic security feature 2 demetallised regions 12 may be created in the reflective metallisation layer 10, for example by chemical etching or laser evaporation, forming an area, pattern or text which allows visibility through the metallised layer 10 to the lower layers. Metallisation with a secondary reflective coating is also possible during the manufacture of the holographic security feature 2 after the initial demetallisation, resulting in areas of the hologram having two different metallic colours, e.g. aluminium and copper. This structure may then be further partially demetallised to create transparent demetallised regions 12.

On top of the metallised layer 10 the structure is coated with heat-sensitive adhesive 11 designed for bonding to the protective film 6 during hot-stamping process. The adhesive used in layer 11 is inherently transparent after application in order to ensure good readability of the holographic image from the side of the protective film 6. Where the security item is designed for outdoor use, as in the case of a licence plate, the adhesive used is both temperature resistant and UV resistant and may include one or more UV absorbers, such as aromatic ketones and/or hindered amine light stabilisers. These properties prevent the adhesive from acquiring unwanted coloration, bubbling, cracking or otherwise degrading in long term exposure to sunlight and low or high temperatures.

The adhesive may also include a security fluorescent additive or machine-readable additive, for example an up-converting phosphor which emits visible fluorescence of a predetermined colour when exposed to an infrared laser or a similar additive which can generate a yes/no light or sound response in a laser-based detector to confirm the authenticity of the holographic security feature 2. The fluorescence or machine-readable optical response will be detectable over the entire area of the holographic security feature when viewed through the top protective film 6. Alternatively such security fluorescent or machine-readable additives may be added to the embossable layer 9.

FIG. 4 shows schematically the layer structure of the holographic security feature 2 comprising holographic hot-stamping foil after it has been applied to the protective film 6. During application under heat and pressure the carrier film 7 is released from the structure and heat-sensitive adhesive 11 activates to provide a permanent bond between the structure and the protective film 6.

An additional optically active layer 13 may be provided after the holographic security feature 2 has been applied to the protective film 6, for example by overprinting with a colour-switching ink, liquid crystal ink, or overprinting or overcoating with varnish including a security fluorescent or machine-readable additive, for example a UV fluorescent additive or an up-converting phosphor which emits visible fluorescence of a predetermined colour when exposed to an infrared laser or a similar additive generating a yes/no light or sound response in a laser-based detector to confirm the authenticity of the holographic security feature 2. Advantageously, if during the manufacture of the holographic security feature 2 the reflective metallisation layer 10 is provided with demetallised regions 12 forming a pattern or text which allows visibility through the metallised layer 10 to the lower layers, the optically active layer 13 will become partially visible. In this case, when viewed through the top protective film 6, a colour-shift effect or fluorescence will be seen only through the demetallised areas of the holographic image, increasing security and counterfeit resistance of the holographic security feature 2.

The holographic security feature 2 is normally applied in such a way that on the finished item, such as a licence plate, it is positioned at least 5 mm away from the edges of the item so that the edge of the hologram is not exposed to the environment, which would reduce durability.

The holographic security feature 2 can also be applied to the reverse of the protective film 6 as a self-adhesive label using pressure-sensitive adhesive.

The protective film 6 including the holographic security feature 2 represented in FIG. 4 can be applied to the retroreflective layer 5 to form a retroreflective laminate, at which point the carrier film 14 is removed. The holographic security feature 2 is sandwiched between the protective film 6 and the retroreflective layer 5, such that the hologram is protected by the protective film 6. The resulting laminate is then applied to the base 4 of the licence plate so that the protective film 6 provides the outermost layer of the licence plate. Heat-sensitive or pressure-sensitive adhesive may be used for such application.

The retroreflective laminate comprising the protective film 6 with the holographic security feature 2 and the retroreflective layer 5 can be applied to the base 4 while the licence plate is still flat, i.e. before the vehicle registration number is embossed and/or printed.

Before or after the holographic security feature 2 is applied to the protective film 6, the film 6 may be reverse-printed, for example with an ISO country code and national colours. It is beneficial to register the holographic security feature 2 to the printing or vice versa to ensure that on the finished item the holographic security feature 2 is always in the correct position relative to the printing and the base 4. Printed registration marks may then be used to ensure that both the holographic security feature 2 and the print are always in the same position relative to the base 4 of the licence plate or other security item.

In accordance with the invention, the metallised layer 10 of the holographic security feature 2 is laser-marked with identifying information that is specific to the particular licence plate or vehicle after the retroreflective security laminate including the protective film 6, the holographic security feature 2 and the retroreflective layer 5 has been applied to the licence plate. The identifying information may be the vehicle registration number 3 that appears on the licence plate. Alternatively, the identifying information may be a vehicle identification number (VIN) of the vehicle to which the licence plate is to be applied. Other identifying information could be used, typically in the form of alphanumeric characters, but alternative variable security patterns are possible, such as machine-readable codes, e.g. bar codes. In this way, the licence plate includes an additional security feature—the plate-specific holographic security feature—that is difficult to counterfeit, making the licence plate as a whole more difficult to counterfeit. Where the holographic security feature 2 includes an optically active layer 13, when viewed through the top protective film 6, the fluorescence or other effect from the optically active layer 13 will be seen or otherwise detected only through the demetallised areas of the holographic image, providing an additional security feature.

During laser evaporation of the metallised layer 10, the laser beam passes through the transparent protective film 6 and the adhesive layer 11 and vaporises portions of the metallised layer 10 to form the identifying information. Thus, the areas where the holographic security feature 2 is subject to the laser beam are demetallised, resulting in transparent areas revealing the layers beneath the metallisation. The laser evaporation can be carried out at the same time as the vehicle registration number 3 is applied to the licence plate, for example by embossing and thermal transfer printing, so that a single machine is used to apply the vehicle registration number 3 and to carry out the laser evaporation. The machine will be provided with the vehicle registration number to be applied to the licence plate so that the embossing and laser evaporation can be carried out either substantially simultaneously or as sequential steps.

Alternatively, if the vehicle registration number has already been applied to the licence plate by embossing and/or printing, laser evaporation of the portions of metalllised layer from holographic security feature 2 may be carried out at a later time. In this case, the laser evaporation device may be provided with an optical reader, such as a video camera, to read the vehicle registration number from the licence plate and apply the same vehicle registration number to the holographic security feature by laser evaporation. In this case, the video camera reads the printed vehicle registration number sequence from the licence plate, communicates the sequence to a control unit which directs the laser system to reproduce the same vehicle registration number sequence on the hologram.

Laser evaporation may be carried out on the retroreflective security laminate comprising the protective film 6, holographic security feature 2 and the retroreflective layer 5 before the laminate is applied to the base 4 of the licence plate.

In a further development of the laser evaporation process, the laser evaporation device may be in data communication with a (remote) database containing details of vehicle registration numbers (VRN) and associated vehicle identification numbers (VIN) or other identifying information. In this case, a particular vehicle which has had a VIN plate pre-installed by the car manufacturer has been assigned a vehicle registration number by the issuing authority. The laser evaporation device may be configured to read the vehicle registration number from the licence plate and to look up the VIN in the database in order to apply the appropriate VIN to the holographic security feature. This is particularly beneficial because the system informationally connects the vehicle registration number and the physical licence plate with a particular vehicle identified by a VIN in a unique way. In this case the detection by the police of any licence plate substitution is significantly facilitated.

If the retroreflective security laminate is personalised before application to the final item, such as the licence plate, the personalisation may comprise a random alphanumeric sequence which after the application to the item is informationally connected in a database with the alphanumeric data, such as a vehicle registration number, already printed on the item, thereby associating the laminate with the item in a unique way.

Typically, the laser evaporation device will take the form of a computer-controlled laser, such as a Nd:YAG laser. The device may comprise a licence plate feeding system and/or a jig to maintain the licence plate in position for laser marking.

An embodiment of the invention has been described above with particular reference to a vehicle licence plate. However, the invention is of application to other security items, for example passports or identity cards. In this case the top protective film 6 may have adhesive pre-applied to it for further lamination to the finished item before the application of the holographic security feature 2. The security laminate in the case of an identity card or passport may comprise the protective film 6, typically a PET film, coated with PE/EVA or other hot-melt/ heat sensitive adhesive where the holographic security feature is applied to the adhesive side of the security laminate as a self-adhesive label. The laminate is then used for heat-laminating onto a passport page or an ID card to ensure protection of personal data from tamper. The security laminate applied to a passport or an ID card may, after its application to the card or the passport page, have the holographic security feature 2 laser-personalized with the unique sequential passport or ID card number which has already been printed on the passport/card, in the same manner as for the licence plate described above.

The security laminate may comprise solely the protective film 6 with the holographic security feature 2 applied to it as hot-stamping foil or a self-adhesive label, for example when the protective film 6 is polycarbonate film without adhesive, which is laminated to further layers of a polycarbonate ID card using heat and pressure.

The security laminate construction is particularly beneficial when an item is subject to mechanical abrasion (plastic card), chemical reagents and other environmental factors (licence plate) because the hologram which has durability issues when exposed to the above is embedded and protected by the protective film which offers increased durability compared to holograms applied on the surface of the laminate or film. In addition personalisation by laser via the top filmic layer is indelible and is difficult to alter or counterfeit.

In general terms, the invention provides a personalised security laminate where the top protective filmic layer is fully or partially optically transparent, containing an embedded hologram applied to the reverse of the top filmic layer and personalized with variable data by laser through such top filmic layer after the laminate has been assembled. The laminate may be laminated or adhered to a base material to form a finished security item whereby the hologram is personalized with variable data by laser through the top filmic layer after the item has been assembled.

In summary, there is disclosed a method of processing a security item 1. The security item comprises a holographic security feature 2 having at least one metallised layer. The holographic security feature 2 is applied to the reverse of a substantially transparent film through which the holographic security feature is viewed in use of the security item. The transparent film protects the holographic security feature from the environment in the finished security item. The method includes the step of applying laser radiation to the metallised layer of the holographic security feature through the transparent film to remove a portion of the metallisation to define a pattern of identifying information on the holographic security feature. The method has the advantage that the hologram can be customised with identifying information after the manufacture of the security item.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A method of processing a security item, the security item comprising a holographic security feature having at least one metallised layer, the holographic security feature being applied to the reverse of a substantially transparent film through which the holographic security feature is viewed in use of the security item such that the transparent film protects the holographic security feature from the environment in the finished security item, the method comprising the step of applying laser radiation to the metallised layer of the holographic security feature through the transparent film to remove a portion of the metallisation to define a pattern of identifying information on the holographic security feature.

2. A method as claimed in claim 1, wherein the pattern of identifying information is alphanumeric.

3. A method as claimed in claim 1, wherein the pattern of identifying information is specific to the particular security item.

4. A method as claimed in claim 1, wherein the security item contains an optically active layer on the opposite side of the metallised layer to the transparent film.

5. A method as claimed in claim 1, wherein the step of applying laser radiation to the metallised layer comprises machine-reading information from the security item in order to determine the identifying information to be applied to the holographic security feature.

6. A method as claimed in claim 5, wherein the dentifying information is the information read from the security item.

7. A method as claimed in claim 5, wherein the step of determining the identifying information includes looking up the information read from the security item in a database.

8. A method as claimed in claim 7, wherein the step of determining the identifying information includes extracting the identifying information from the database.

9. A method as claimed in claim 1, wherein the security item is a vehicle licence plate.

10. A method as claimed in claim 1, wherein the security item is an identity card or passport.

11. A method as claimed in claim 1, wherein the security item is a laminate material.

12. A method as claimed in claim 11, wherein the laminate material comprises an adhesive on a surface opposed to the surface of the transparent film.

13. A method as claimed in claim 11, wherein the laminate material comprises a retroreflective layer.

14. A security item adapted for processing in accordance with the method of claim 1.

15. A computer controlled laser configured to carry out the method of claim 1.
